(19) United States
(12) Patent Application Publication
(10) Pub. No.: US 2007/0124008 A1
(43) Pub. Date: May 31, 2007

(54) Design support system and design support method

(76) Inventor: Yusuke Imaizumi, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/603,372

(22) Filed: Nov. 22, 2006

(30) Foreign Application Priority Data
Nov. 30, 2005 (JP) 2005-347111

(51) Int. Cl. G06F 19/00

(52) U.S. Cl. 700/98; 700/97

(57) ABSTRACT

According to one embodiment, a design support system which supports verification of design of a product, the system includes material information acquiring unit which acquires information on a material for each of the part shape models for the product including a housing, reference ground setting unit which sets one of the part shape models to be a reference ground, extracting/measuring unit which extracts conductive paths from the part shape models ranging from the part shape model set to be check target to the part shape model serving as the reference ground on the basis of the information on the material for each of the part models, and measuring the lengths of the extracted paths, and detecting unit which detects where electromagnetic radiation of a level equal to or greater than a criterion value is likely to leak outside the housing.

### CROSS-REFERENCE TO RELATED APPLICATIONS

This application is based upon and claims the benefit of priority from Japanese Patent Application No. 2005-347111, filed Nov. 30, 2005, the entire contents of which are incorporated herein by reference.

### BACKGROUND

1. Field

One embodiment of the invention relates to a design support system and a design support method which check whether or not electromagnetic radiation may leak from a housing.

2. Description of the Related Art

The amount of electromagnetic radiation emanating from electronic instruments is restricted. To prevent the amount of electromagnetic radiation emanating from an electronic instrument from exceeding the range stipulated by regulations, electromagnetic field analysis is started at the stage of product design to determine where in the product electromagnetic radiation is likely to leak and so cause trouble (Jpn. Pat Appln. KOKAI Publication No. 2002-149720).

However, electromagnetic field analysis requires a very long time. This delays taking appropriate action for parts from which electromagnetic radiation is likely to leak, increasing the time required to design the product. However, to reduce the time required to design the product, it is desirable to easily determine where electromagnetic radiation is likely to leak.

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the general configuration of an EMC design support system according to an embodiment of the present invention;

FIG. 2 is an exemplary diagram showing the structure of CAD data according to the embodiment of the present invention;

FIG. 3 is an exemplary diagram of part shapes expressed on the basis of CAD data according to the embodiment of the present invention;

FIG. 4 is an exemplary diagram showing the correspondence between a PRT file and material information;

FIG. 5 is an exemplary diagram showing an example in which conductive-plating application range information is incorporated into the PRT file;

FIG. 6 is an exemplary flowchart showing the procedure of a process executed by the EMC design support system according to the embodiment of the present invention;

FIG. 7 is an exemplary diagram showing the configuration of a circuit board, a housing base, and a housing cover expressed on the basis of CAD data;

FIG. 8 is an exemplary diagram showing connections with a reference ground on the circuit board; and

FIG. 9 is an exemplary table showing determinations made by the EMC design support system according to the embodiment of the present invention.

### DETAILED DESCRIPTION

Various embodiments according to the invention will be described hereinafter with reference to the accompanying drawings. In general, according to one embodiment of the invention, a design support system which supports verification of design of a product, includes, check target setting unit which sets a part shape model to be a check target, from a plurality of part shape models for the product including a housing, material information acquiring unit which acquires information on a material for each of the plurality of part shape models, reference ground setting unit which sets one of the plurality of part shape models to be a reference ground, extracting/measuring unit which extracts conductive paths from the part shape models ranging from the part shape model set to be the check target to the part shape model serving as the reference ground, on the basis of the information on the material for each of the part models, and measuring the lengths of the extracted paths, and detecting unit which detects where electromagnetic radiation of a level equal to or greater than a criterion value is likely to leak outside the housing.

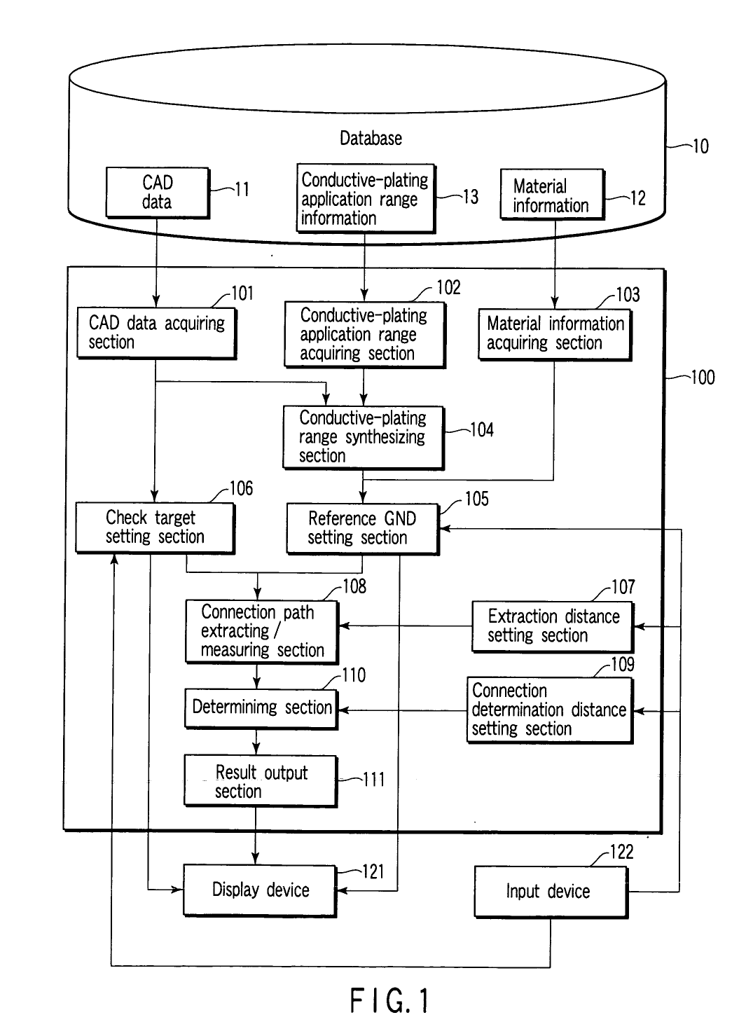

FIG. 1 is a block diagram showing the configuration of an electromagnetic compatibility (EMC) design support system.

An EMC design support system 100 has a computer-aided design (CAD) data acquiring section 101, a material information acquiring section 102, and a conductive-plating application range acquiring section 103 which acquire various items of data (information) from a database 10.

The CAD data acquiring section 101 acquires CAD data 11 from the database 10. The material information acquiring means 102 acquires material information 12 from the database 10. The conductive-plating application range acquiring section 103 acquires conductive-plating application range information 13 from the database 10.

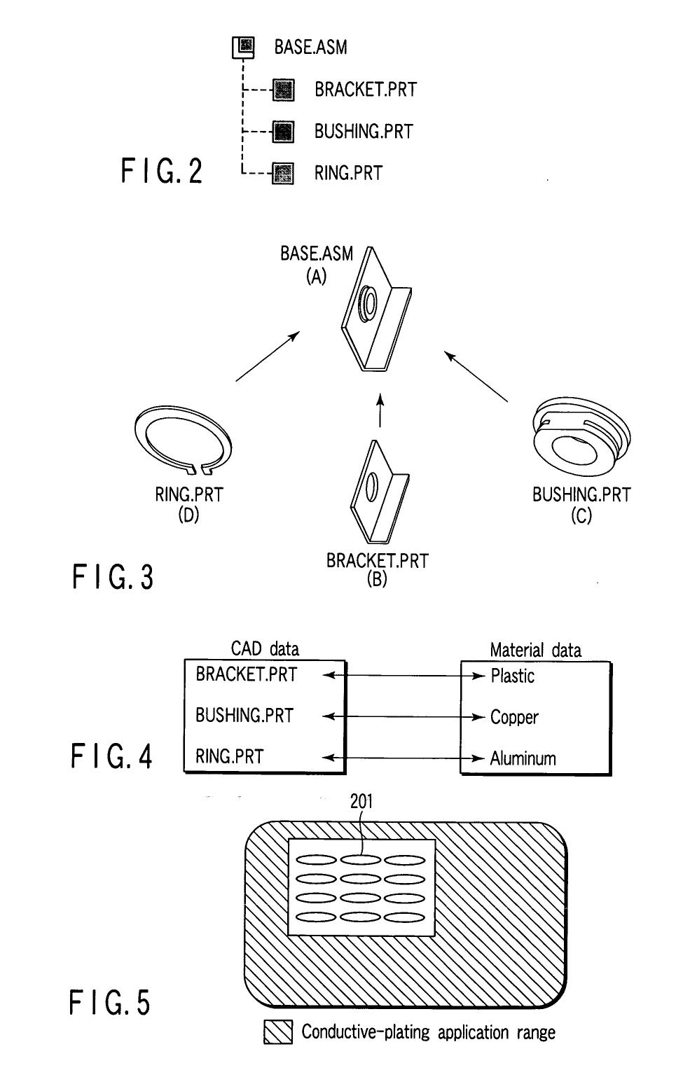

The CAD data 11 acquired by the CAD data acquiring section 101 is formed of a plurality of small assembled files. For example, as shown in FIG. 2, the CAD data 11 indicates a tree structure. Specifically, BASE.ASM is composed of an assembly of three files (part shape models), BRACKET.PRT, BUSHING.PRT, and RING.PRT. Files for individual parts are hereinafter referred to as PRT files. A collection of PRT files is hereinafter referred to as an ASM file. However, an ASM file may contain a plurality of ASM files.

FIG. 3A shows a part shape expressed on the basis of BASE.ASM. FIG. 3B shows a part shape expressed on the basis of BRACKET.ASM. FIG. 3C shows a part shape expressed on the basis of BUSHING.ASM. FIG. 3D shows a part shape expressed on the basis of RING.ASM.

The material information acquiring section 102 acquires the material information 12 from the database 10. The PRT file contains data on the shape of a part but may not contain the material information. To execute checks on the basis of EMC, it is important to distinguish metal from nonmetal. The database 10 stores the material information for each PRT file. If possible, physical property values such as conductivity are added to the database 10. The material information 12 acquired by the material information acquiring section 102 is associated with each PRT file for the CAD data 11, as shown in FIG. 4.

The conductive-plating application range acquiring section 103 acquires the conductive-plating application range information 13 from the database 10. In designing a digital instrument, the interior of a nonconductive housing may be conductively plated in order to hinder noise from a circuit board from leaking outside the instrument. In connection with EMC, the range of application of conductive plating is important. If possible, physical property values such as the conductivity of the conductive plating are added to the conductive-plating application range information 13.

A conductive-plating range synthesizing section 104 incorporates conductive-plating application information in the conductive-plating application range information 13 into the PRT file in the CAD data acquired by the CAD data acquiring section 101. FIG. 5 shows an example in which the conductive-plating application range information is incorporated into the PRT file. In the example shown in FIG. 5, the instrument is conductively plated except for an area in which heat exhaust apertures 201 are formed.

A reference ground setting section 105 uses a connection path extracting/measuring section 108 to set a part or area serving as a reference ground for a housing frame. The part or area serving as the reference ground for the housing frame is set in accordance with a user's specification. For example, the reference ground setting section 105 displays, on a display device 121, a structure corresponding to the ASM file. During display, the reference ground setting section 105 displays conductive parts and a conductive-plating application range in a special manner. The user selects from the special display portions via an input device 122 such as a mouse to specify the part or area serving as the reference ground. A plurality of parts and areas serving as reference grounds can be selected. Alternatively, it is possible to select from the ASM files or PRT files. If only a portion of a part is conductively plated, only that conductive-plating application area can be specified as a reference ground.

A check target setting section 106 sets a part to be checked in the connection path extracting/measuring section 108. The part or area to be checked is set in accordance with the user's specification. For example, the check target setting section 106 displays the structure corresponding to an ASM file, on the display device 121. Then, in response to the user's selection via the input device 122 such as a mouse, the check target setting section 106 specifies the part or area to be checked. A plurality of parts or areas serving as reference grounds can be selected. Alternatively, it is possible to select from the ASM files or PRT files.

An extraction distance setting section 107 sets, in the connection path extracting/measuring section 108, an extraction distance Lmax input by the user via the input device 122 such as a keyboard.

The connection path extracting/measuring section 108 extracts, from the check a target part or area set by the check target setting section 106, all “conductive” paths to the reference ground part or area set by the reference ground setting section 105, within the range of the extraction distance Lmax set by the extraction distance setting section 107. The connection path extracting/measuring section 108 measures the length of each of the extracted paths. The connection path extracting/measuring section 108 supplies the extracted paths and the path lengths to a determining section 110.

A connection determination distance setting section 109 sets, in the determining section 110, a connection determination distance L input by the user via the input device 122 such as a keyboard.

The determining section 110 determines whether or not electromagnetic radiation of a level equal to or higher than a criterion value is likely to leak at the measured distance of each path supplied by the connection path extracting/measuring section 108, on the basis of the connection determination distance L set by the connection determination distance setting section 109. The determining section 110 supplies determinations to a result output section 111. A greater connection distance is likely to increase the amount of electromagnetic radiation generated. Thus, if the path length determined by the connection path extracting/measuring section 108 is equal to or greater than the connection determination distance L, the determining section 110 determines that electromagnetic radiation of the level equal to or higher than a criterion value is likely to leak.

The result output section 111 displays, on the display device, the determinations supplied by the determining section 110.

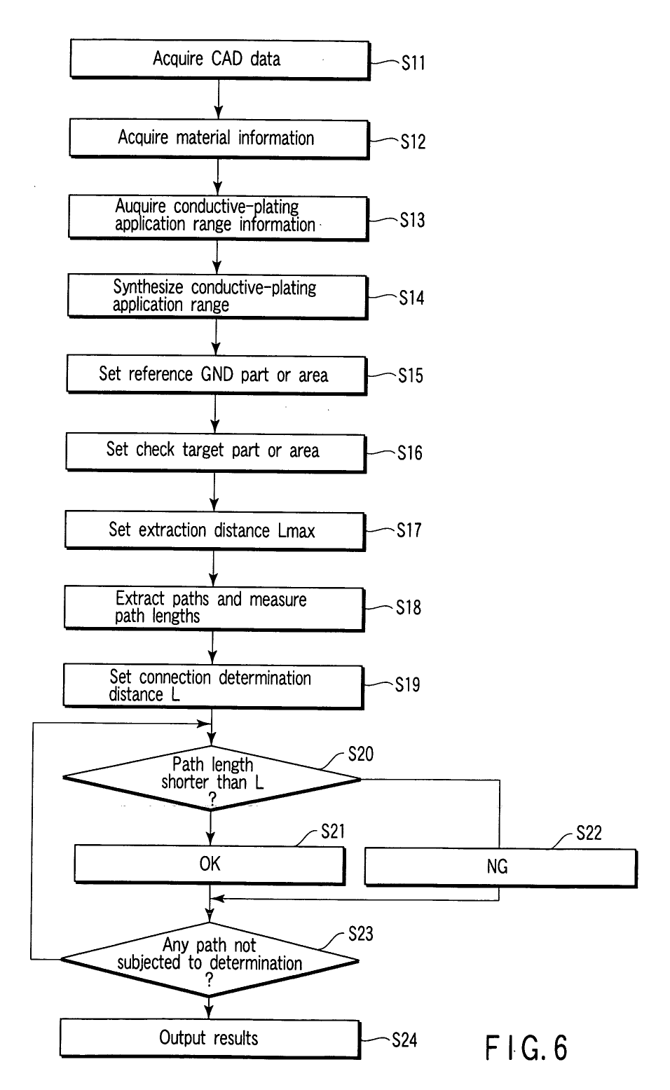

Now, an actual procedure will be described with reference to the flowchart in FIG. 6.

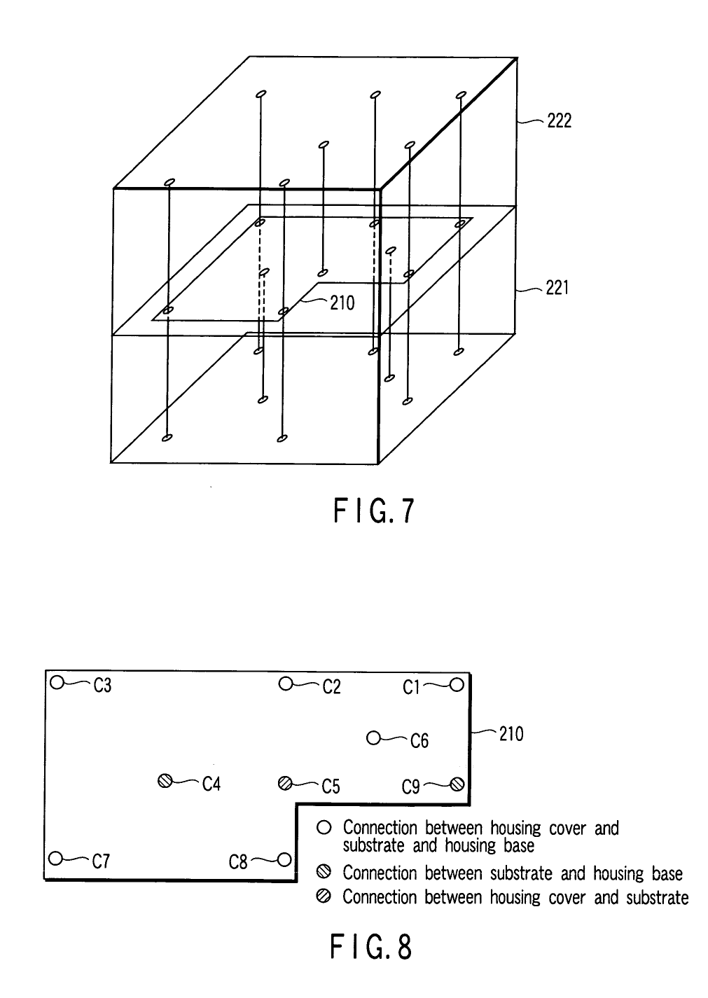

First, the CAD data acquiring section 101 acquires mechanical CAD data 11 containing the check target part or area from the database 10 (block S11). For example, as shown in FIG. 7, CAD data 11 is acquired which indicates that a circuit board 210 that generates electromagnetic radiation is installed inside a housing base 221 and a housing cover 222.

Then, the material information acquiring section 102 acquires the material information 12 from the database 10 (block S12). The housing base 221 and the housing cover 222 are plastic parts (nonconductive parts).

The conductive-plating application acquiring section 103 acquires the conductive-plating application range information 13 from the database 10 (block S13). Since the housing base 221 and housing cover 222 are partly conductively plated, the conductive-plating application acquiring section 103 acquires the conductive-plating application range information 13 corresponding to the housing base 221 and housing cover 222.

The conductive-plating range synthesizing section 104 then incorporates conductive-plating application information in the conductive-plating application range information 13 into a PRT file in the CAD data acquired by the CAD data acquiring section 101 (block S14).

The reference ground setting section 105 then sets, in the connection path extracting/measuring section 108, a part or area serving as a reference ground (block S15). In this case, the conductive plating applied to the parts of the housing 221 and housing cover 222 is a reference ground.

The check target setting section 106 then sets a check target part or area in the connection path extracting/measuring section 108 (block S16). In the present embodiment, the check target is set to be the circuit board 210.

The extraction distance setting section 107 then sets, in the connection path extracting/measuring section 108, an extraction distance Lmax input by the user via the input device 122 (block S17). This processing may be executed at any time before the processing in the next block S18 is executed.

The connection path extracting/measuring section 108 then extracts, from the check target part or area set by the check target setting section 106, all “conductive” paths to the reference ground part or area set by the reference ground setting section 105 within the range of the extraction distance Lmax set by the extraction distance setting section 107. The connection path extracting/measuring section 108 measures the length of each of the extracted paths (block S18). The connection path extracting/measuring section 108 supplies the extracted paths and the path lengths to the determining section 110. As shown in FIG. 8, connection positions C1, C2, C3, C7, C8, and C9 on the circuit board 210 are connected to the housing base 221 and the housing cover 222. Connection positions C4 and C6 on the circuit board 210 are connected to the housing base 221. A connection position C5 on the circuit board 210 is connected to the housing cover 222.

The connection determination distance setting section 109 sets, in the connection path extracting/measuring section 108, a connection determination distance L input by the user via the input device 122 (block S19). This processing may be executed at any time before the processing in the next block S20 is executed.

The determining section 110 selects one of the paths extracted by the connection path extracting/measuring section 108. The determining section 110 determines whether or not the measured length of the selected path is less than the connection determination distance L set by the connection determination distance setting section 109 (block S20).

If the measured length is less than the connection determination distance L (Yes in block S20), the determining section 110 assumes that the amount of electromagnetic radiation likely to leak from the selected path to the outside of the housings 221 and 222 is less than the criterion value. The determining section 110 thus determines that the selected path is OK (block S21). If the measured length is equal to or greater than the connection determination distance L (No in block S20), the determining section 110 assumes that the amount of electromagnetic radiation likely to leak from the selected path to the outside of the housings 221 and 222 is equal to or greater than the criterion value. The determining section 110 thus determines that the selected path is NG (block S22).

After the processing in block S21 or S22, the determining section 110 determines whether or not any of the paths extracted by the connection path extracting/measuring section 108 has failed to be subjected to determination (block S23). If any path has failed to be subjected to determination (Yes in block S23), the determining section 110 selects that path having failed to be subjected to determination and executes the processing in block S20.

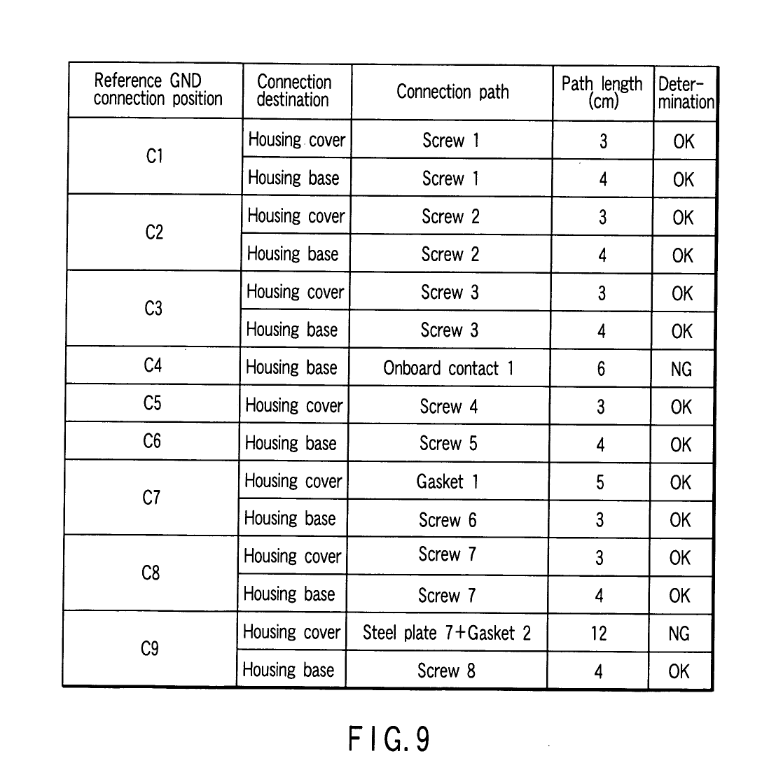

If all the paths have been subjected to determination (No in block S23), the result output section 111 shows, on the display device 121, the determinations for all the paths extracted by the connection path extracting/measuring section 108 (block S24). FIG. 9 shows the determinations. As shown in FIG. 8, when displayed, the connections may be classified into those between the substrate 210 and the housing base 221 and housing cover 222, those between the substrate 210 and the housing base 221, and those between the housing cover 222 and the substrate 210.

The housing can be easily checked for areas of possible leakage of electromagnetic radiation by extracting the frame ground connection structure at a time and determining whether or not electromagnetic radiation of a level equal to or greater than the criterion value is likely to leak on the basis of the connection path length. Parts that are likely to cause trouble can be mechanically extracted. This makes it possible to quickly take measures against the leakage of electromagnetic radiation and to reduce the time required for product design.

Preferably, the present support system further has a function for displaying conductive paths. Preferably, the present support system further has a function for approximating a resistance value from the physical values of the part located between the connection paths. Preferably, the present support system further has a function for creating a report on check results as shown in FIG. 9. Preferably, the present support system further has a function for checking whether or not the connection interval is valid for the frequencies of signals used in the instrument.

A computer program implements all of the processing required to check where in a housing electromagnetic radiation is likely to leak according to the present invention. Accordingly, effects similar to those of the present embodiment can be easily realized simply by installing this computer program in a normal computer through a computer readable storage medium. The computer program can be executed not only on a personal computer but also on various electronic instruments containing processors.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A design support system which supports verification of design of a product, the system comprising:
check target setting unit which sets a part shape model to be a check target, from a plurality of part shape models for the product including a housing;
material information acquiring unit which acquires information on a material for each of the plurality of part shape models;
reference ground setting unit which sets one of the plurality of part shape models to be a reference ground;
extracting/measuring unit which extracts conductive paths from the part shape models ranging from the part shape model set to be the check target to the part shape model serving as the reference ground, on the basis of the information on the material for each of the part models, and measuring the lengths of the extracted paths; and
detecting unit which detects where electromagnetic radiation of a level equal to or greater than a criterion value is likely to leak outside the housing.

2. The design support system according to claim 1, further comprising:
acquiring unit which acquires conductive plating application range information indicating a range over which conductive plating is applied to the plurality of part shape models which are to be conductively plated; and
incorporating unit which incorporates the conductive plating application range information into the part shape models corresponding to the conductive-plating application range information,
wherein the extracting/measuring unit extracts conductive paths from the part shape models ranging from the part shape model set to be the check target to the part shape model serving as the reference ground on the basis of the information on the material for each of the part models and the conductive-plating application range information incorporated into the part shape models.

3. The design support system according to claim 1, wherein the detecting unit detects that any of the extracted paths the path length of which is equal to or greater than a determination distance is an area from which electromagnetic radiation of the level equal to or greater than the criterion value is likely to leak outside the housing.

4. The design support system according to claim 1, wherein the extracting/measuring unit extracts paths within the range of a preset extraction distance.

5. A design support method which supports verification of a product design using a computer, the method comprising:
setting a part shape model to be a check target, from a plurality of part shape models for the product including a housing;
acquiring information on a material for each of the plurality of part shape models;
setting one of the plurality of part shape models to be a reference ground;
extracting conductive paths from the part shape models ranging from the part shape model set to be the check target to the part shape model serving as the reference ground, on the basis of the information on the material for each of the part models, and measuring the lengths of the extracted paths; and
detecting where electromagnetic radiation of a level equal to or greater than a criterion value is likely to leak outside the housing.

6. The design support method according to claim 5, further comprising:
acquiring conductive plating application range information indicating a range over which conductive plating is applied to the plurality of part shape models which are to be conductively plated; and
incorporating the conductive plating application range information into the part shape models corresponding to the conductive-plating application range information,
extracting conductive paths from the part shape models ranging from the part shape model set to be the check target to the part shape model serving as the reference ground on the basis of the information on the material for each of the part models and the conductive-plating application range information incorporated into the part shape models.

7. The design support method according to claim 5, wherein the detecting detects that any of the extracted paths the path length of which is equal to or greater than a determination distance is an area from which electromagnetic radiation of the level equal to or greater than the criterion value is likely to leak outside the housing.

8. The design support method according to claim 5, wherein the extracted paths are within the range of a preset extraction distance.

9. A program allowing a computer to execute a process which supports verification of a product design using a computer, the program comprising:
a procedure of allowing the computer to execute a process for setting a part shape model to be a check target, from a plurality of part shape models for the product including a housing;
a procedure of allowing the computer to execute a process for acquiring information on a material for each of the plurality of part shape models;
a procedure of allowing the computer to execute a process for setting one of the plurality of part shape models to be a reference ground;
a procedure of allowing the computer to execute a process for extracting conductive paths from the part shape models ranging from the part shape model set to be the check target to the part shape model serving as the reference ground, on the basis of the information on the material for each of the part models, and measuring the lengths of the extracted paths; and
a procedure of allowing the computer to execute a process for detecting where electromagnetic radiation of a level equal to or greater than a criterion value is likely to leak outside the housing.

10. The program according to claim 9, further comprising:
a procedure of allowing the computer to execute a process for acquiring ? conductive plating application range information indicating a range over which conductive plating is applied to the plurality of part shape models which are to be conductively plated; and
a procedure of allowing the computer to execute a process for incorporating the conductive plating application range information into the part shape models corresponding to the conductive-plating application range information, the extracting/measuring procedure allows the computer to execute a process for extracting conductive paths from the part shape models ranging from the part shape model set to be the check target to the part shape model serving as the reference ground on the basis of the information on the material for each of the part models and the conductive-plating application range information incorporated into the part shape models.

11. The program according to claim 9, wherein the detecting detects that any of the extracted paths the path length of which is equal to or greater than a determination distance is an area from which electromagnetic radiation of the level equal to or greater than the criterion value is likely to leak outside the housing.

12. The program according to claim 9, wherein the extracted paths are within the range of a preset extraction distance.
